(19) United States
(12) Patent Application Publication
(10) Pub. No.: US 2005/0187773 A1
(43) Pub. Date: Aug. 25, 2005

(54) Voice synthesis system

(75) Inventors: Pascal Filoche, Perros-Guirec (FR); Paul Miquel, Lannion (FR); Edouard Hinard, Lannion (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: FRANCE TELECOM, Paris (FR)

(21) Appl. No.: 11/047,556

(22) Filed: Feb. 2, 2005

(30) Foreign Application Priority Data
Feb. 2, 2004 (FR) 0400958

(51) Int. Cl. G10L 13/00

(52) U.S. Cl. 704/260

(57) ABSTRACT

A voice synthesis system for interactive voice services comprises a voice server connected to a packet network dispensing a voice service to a user terminal by executing a service file associated with the voice service. An HTTP client in the voice server transmits a request containing a text to be synthesized during execution of the service file. The service file includes an address designating a resource in a voice synthesis server connected to the packet network and a command responsive to the audio format for commanding the transmitting of the request to the voice synthesis server. An HTTP server in the voice synthesis server transmits to the voice server an audio response including the text that has been synthesized by the voice synthesis server independently of the voice server.

### CROSS-REFERENCE TO RELATED APPLICATION

This application claims priority under 35 U.S.C. §119 based on French Application No. 0400958, filed Feb. 2, 2004, the disclosure of which is incorporated by reference herein in its entirety.

### BACKGROUND OF THE INVENTION

1. Field of the Invention

The present invention relates to a system and a method of voice synthesis. The invention relates more particularly to a system and a method of voice synthesis for interactive voice services conceived in a voice services management server and dispensed to a user terminal by an interactive voice server.

2. Description of the Prior Art

Interactive voice servers known in the art directly integrate voice synthesizers that synthesize text conventionally included in VXML (Voice extensible Markup Language) files. Specific VXML flags indicate text portions to be synthesized to the interactive voice server.

At present, although emergent languages such as SSML (Speech Synthesis Markup Language) control certain characteristics at the voice synthesis level and at the voice recognition level, no voice synthesis system has completely dispensed with synthesizers in interactive voice servers. Consequently, voice service providers must conform to the characteristics of existing voice server synthesizers, which considerably limits the field of application of voice synthesis. For example, a text formatted specifically for a particular use, such as RFC822 electronic mail (e-mail), cannot be synthesized directly by an interactive voice server without modifying the voice server itself, which obliges service providers to be dependent on voice service providers.

### OBJECT OF THE INVENTION

An object of the present invention is to render voice synthesis independent of an interactive voice server in order to be able to carry out voice synthesis specific to a text to be synthesized without calling on a voice server.

### SUMMARY OF THE INVENTION

Accordingly, a voice synthesis system for interactive voice services comprises an interactive voice server connected to a packet network dispensing a voice service to a user terminal by executing a service file associated with said voice service, and a voice synthesis server connected to the packet network and including voice synthesis means. The voice synthesis system is characterized in that it comprises:
means in the interactive voice server for transmitting a request containing a text to be synthesized during the execution of the service file, the service file including an address designating a resource in the voice synthesis server and a command responsive to the audio format for commanding transmitting of the request to the voice synthesis server,
means in the voice synthesis server for transforming the text to be synthesized into a transformed text as a function of a formatting file that is a parameter of the address of the resource in order for the voice synthesis means to synthesize the transformed text into synthesized text, and
means in the voice synthesis server for transmitting to the interactive voice server an audio response to said request including the synthesized text.

The service file includes the address designating a resource in the voice synthesis server and the command responsive to the audio format for commanding transmitting of the request in order for the interactive voice server to accept only one audio response to said request. Because the text to be synthesized is a parameter of the address of the resource, voice synthesis in accordance with the invention is easier and faster.

The text to be synthesized may also be located by another resource address that is a parameter of the resource address.

Before the voice synthesis means synthesizes the text to be synthesized, the transforming means transforms the text to be synthesized as a function of characteristics of the text to be synthesized. The characteristics of the text to be synthesized may be a type, a format and a language of the text. The type of the text to be synthesized may indicate an electronic mail, a short message or a multimedia message.

The transformation means can also transform the text to be synthesized as a function of characteristics of the voice synthesis means before the voice synthesis means synthesizes the text to be synthesized.

According to one advantageous aspect of the invention, the voice synthesis server may also comprise means for determining the language of the text to be synthesized and means for translating the text to be synthesized into a translation language different from the language of the text to be synthesized that has been determined. The voice synthesis means then synthesizes the translated text into a synthesized text in the translation language.

Preprocessing of the text such as transforming and translating it are advantageously effected just before voice synthesis of the text in order to prepare the text to be synthesized for specific voice synthesis, for example.

The voice synthesis system may comprise plural voice synthesis means, one of which may be included in the voice synthesis server, and which are divided between voice synthesis servers connected via the packet network. The voice synthesis server then selects one of the voice synthesizing means to synthesize the text to be synthesized as a function of characteristics of the text to be synthesized.

The invention also relates to a voice synthesis method for interactive voice services comprising execution of a service file in an interactive voice server connected to a packet network in order to dispense to a user terminal a voice service associated with said service file. The method of the invention is characterized in that it comprises the following steps:
transmitting a request containing a text to be synthesized to a voice synthesis server connected to the packet network during the execution of the service file, the service file including an address designating a resource in the voice synthesis server and a command responsive to an audio format to command transmitting of the request,
transforming the text to be synthesized into a transformed text as a function of a formatting file that is a parameter of the address of the resource in order for voice synthesis means in the voice synthesis server to synthesize the transformed text into a synthesized text, and
transmitting an audio response to said request including the synthesized text to the interactive voice server.

The invention also relates to a voice synthesis server for interactive voice services connected via a packet network to an interactive voice server dispensing a voice service to a user terminal by executing a service file associated with said voice service and including voice synthesis means. The voice synthesis server is characterized in that it comprises:
means for transforming a text to be synthesized, transmitted by the interactive voice server during the execution of the service file in a request, the service file also containing an address designating a resource in the voice synthesis server and a command responsive to the audio format for commanding transmitting of the request, into a transformed text as a function of a formatting file that is a parameter of the address of the resource in order for the voice synthesis means to synthesize the transformed text into a synthesized text, and
means for transmitting to the interactive voice server an audio response to said request including the synthesized text.

### BRIEF DESCRIPTION OF THE DRAWINGS

The foregoing and other features and advantages of the present invention will be apparent from the following detailed description of several embodiments of the invention with reference to the corresponding accompanying drawings, in which:

FIG. 1 is a block schematic of a voice synthesis system for interactive voice services provided by a voice services management server and dispensed by an interactive voice server of the invention;

FIG. 2 is an algorithm of consultation of a voice service from a user terminal in accordance with the invention; and

FIG. 3 is an algorithm of the method of the invention of voice synthesis of a text.

### DESCRIPTION OF THE PREFERRED EMBODIMENTS

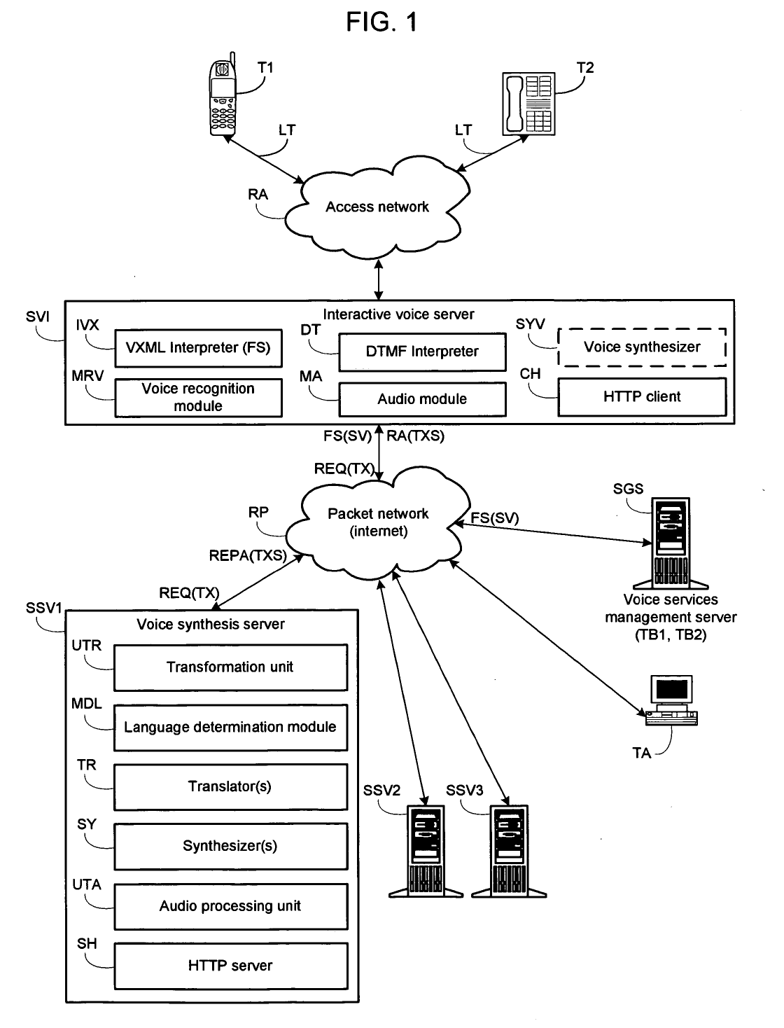

Referring to FIG. 1, the voice synthesis system of the invention comprises mainly an interactive voice server SVI, a voice services management server SGS coupled to an administrator terminal TA, at least one voice synthesis service SSV, and at least one user terminal T. FIG. 1 shows three voice synthesis servers SSV1, SSV2 and SSV3 and two user terminals T1 and T2 respectively and interchangeably designated SSV and T in the remainder of the description.

The interactive voice server SVI communicates with the voice services management server SGS and the voice synthesis server SSV via a high bit rate packet network RP of the Internet type and with user terminals T connected via an access network RA.

In the embodiment shown in FIG. 1, the terminal T is connected to the access network RA by a connection LT.

For example, the terminal T is a cellular mobile radio communication terminal T1, the connection LT is a radio communication channel and the access network RA comprises the fixed network of a radio communication network, for example of the GSM (Global System for Mobile communications) type with a GPRS (General Packet Radio Service) facility, or of the UMTS (Universal Mobile Telecommunications System) type.

In another embodiment, the terminal T is a fixed telecommunication terminal T2, the connection LT is a telephone line and the access network RA is the switched telephone network.

In other embodiments, the user terminal T comprises an electronic telecommunication device or object personal to the user, for example a communicating personal digital assistant PDA. The terminal T may be any other portable or non-portable domestic terminal such as a personal computer having a loudspeaker and connected directly by modem to the connection LT, a video games console or an intelligent television receiver cooperating via an infrared link with a remote controller comprising a display or an alphanumeric keyboard and serving also as a mouse.

In other variants, the connection LT is an xDSL (Digital Subscriber Line) or ISDN (Integrated Services Digital Network) line connected to the corresponding access network RA.

The user terminals T and the access network RA are not limited to the above examples and may consist of other terminals and access networks known in the art.

The administrator terminal TA is typically a personal computer connected to the packet network RP through which it communicates with the voice services management server SGS. The administrator terminal TA makes a software interface available to a user with administrator status after connection of the terminal TA to the voice services management server SGS for the latter to edit the voice service that the administrator user wishes to enable. The voice services management server SGS then generates a service file FS containing the description of a voice service SV, generally in VXML (Voice extensible Markup Language), and stores the service file FS in order to make it available to the interactive voice server SVI.

The services management server SGS comprises mainly an HTTP server, a database and software modules.

The interactive voice server SVI comprises mainly and conventionally a VXML interpreter IVX, a voice recognition module MRV, a DTMF (Dual Tone MultiFrequency) interpreter DT, an audio module MA, a voice synthesizer SYV and an HTTP (HyperText Transfer Protocol) client CH.

The voice synthesizer SYV is not used in the present invention and is shown in FIG. 1 to illustrate the known context of the invention. Consequently, the voice synthesizer SYV could be dispensed with.

The interactive voice server SVI also comprises at least one call processing unit for managing voice service calls from the user terminals T. For example, a user terminal T selects a voice service SV of the interactive voice server SVI that executes the VXML service file FS associated with the selected voice service SV and transmitted by the voice services management server SGS at the request of the interactive voice server SVI, as explained in the description of the algorithm for consulting the voice service SV.

According to the invention, the voice synthesis server SSV comprises mainly a transformation unit UTR, a language determination module MDL, at least one translator TR, at least one synthesizer SY, an audio processing unit UTA and an HTTP server SH.

Following reception of a voice service file by the HTTP client CH of the interactive voice service SVI, the HTTP client CH transmits a request REQ containing at least one text to be synthesized TX to the HTTP server SH. The synthesizer SY synthesizes the text TX into a synthesized text TXS which the HTTP server transmits to the interactive voice server SVI in an audio response REPA.

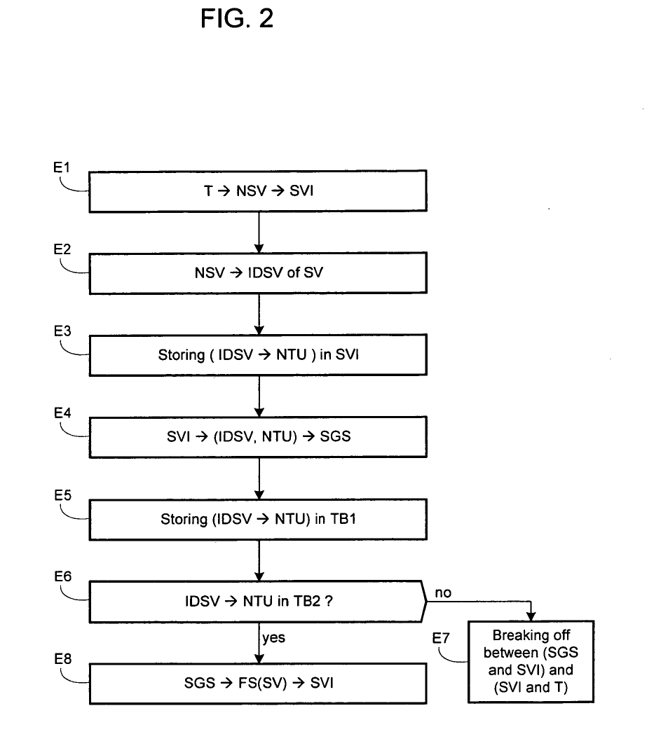

As shown in FIG. 2, the consultation of a voice server SV from a user terminal T essentially comprises steps E1 to E8.

In the step E1, the user terminal T conventionally calls the interactive voice server SVI via the access network RA, for example via the switched telephone network, after the user has entered on the keypad of the terminal T a service telephone number NSV to call directly the voice service SV of his choice in the server SVI. Thus the telephone number NSV is transmitted to the server SVI. The server SVI matches the service number NSV to an identifier IDSV of the voice service SV in the step E2.

The server SVI stores the identifier IDSV of the voice service SV in association with the telephone number NTU of the user terminal T in the step E3 and transmits them in an IP (Internet Protocol) call packet to the services management server SGS via the packet network RP in the step E4.

In the step E5, the services management server SGS stores the pair IDSV-NTU in a table TB1 of the database of the management server SGS and then verifies if the user designated by the number NTU is authorized to consult the voice service SV designated by the identifier IDSV in a table TB2 of the database in the step E6, data relating to a profile of the user is stored beforehand in the table TB2. If the number NTU is not found to match the identifier IDSV in the table TB2, the user is not authorized to consult the selected service and the management server SGS breaks off the call with the voice server SVI which breaks off the call with the user terminal T in the step E7. In the contrary situation, where applicable, the user is invited to enter a confidential access code that the management server SGS receives via the voice server SVI in order to compare it to the one stored in the table TB2 in corresponding relationship to the identifier IDSV. The call is broken off if the code entered is incorrect.

Otherwise, if the user is authorized to consult the voice service SV designated by the identifier IDSV, and where applicable has entered the confidential code correctly the voice services management server SGS transmits, by means of IP packets, the VXML service file FS in corresponding relationship to the voice service SV to the voice server SVI in the step E8, in order for a dialog to be instigated between the terminal T and the voice server SVI for the purpose of browsing the voice service SV.

During execution of the VXML voice service SV in the voice server SVI, and thus during browsing of the voice service SV by the user, the voice server SVI may be invoked conventionally to call a prerecorded sound file designated by a URL (Uniform Resource Locator) address. The URL address refers to a resource situated in the management server SGS or in any server connected to the packet network RP.

In the prior art, the voice server SVI was invoked to synthesize a text or a text file in the voice synthesizer SYV.

In the present invention, the voice server SVI is invoked to transmit a text to be synthesized to the voice synthesis server SSV different from the voice server SVI and connected to the packet network RP.

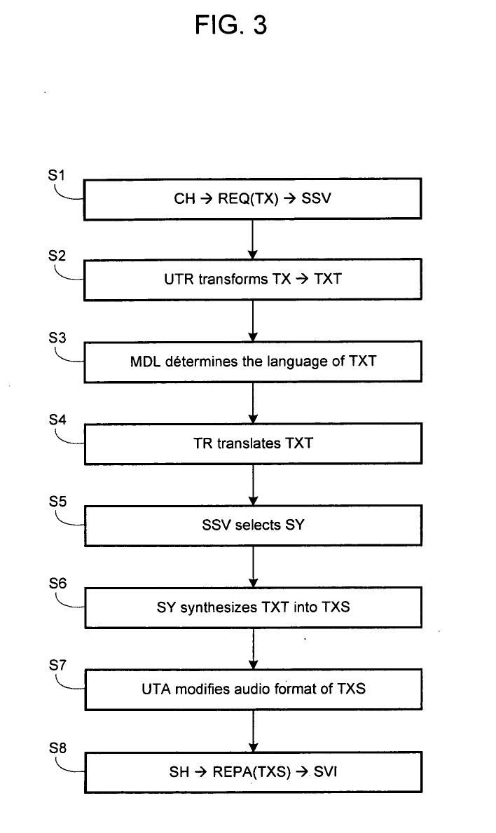

Referring to FIG. 3, the voice synthesis method of the invention comprises mainly steps S1 to S8.

When editing the voice service SV beforehand, the administrator at the administrator terminal TA references the text TX to be synthesized in the synthesis server SSV by introducing a resource address and a command into the service file FS generated by the management server SGS. The address designates a resource in the voice synthesis server SSV. The command is responsive to the audio format and commands transmitting of the request REQ from the voice server SVI in order for the voice server SVI to accept only one audio response REPA to the request REQ.

Appendix 1 shows one example of the VXML command code included in the service file FS, which invokes the VXML “<audio>” flag. The text TX to be synthesized is then a parameter “text” of the resource address.

Alternatively, the text TX to be synthesized is located by a parameter “text” of the resource address comprising a resource address of the text to be synthesized. The voice synthesis server then consults this resource address of the text to be synthesized in order to recover the text TX to be synthesized. The resource address of the text TX to be synthesized points to any server connected to the packet network RP. In this variant, the text TX to be synthesized may be generated dynamically.

Characteristics of the text may constitute additional parameters of the address, such as the type of text to be synthesized (“type”), the translation language (“ltraduc”), the audio format (“format”), the formatting file (“fmf”), etc. The text type defines the text TX to be synthesized, for example a basic text, an electronic mail (e-mail), an SMS (Short Message Service) short message, an MMS (Multimedia Messaging Service) multimedia message, a postal address, etc. The parameter “fmf” defines, in the same way as the parameter “text”, either the content of the formatting file directly or a formatting file resource address enabling the voice synthesis server SSV subsequently to recover the content of the formatting file. The additional parameters are specified by the administrator at the terminal TA when editing the voice service SV. The parameters are automatically coded by the management server SGS for transmitting over the packet network RP in accordance with the HTTP protocol.

During execution of the service file FS, the VXML interpreter IVX in the server SVI comes across the command. At this time, the HTTP client CH transmits the request REQ containing the text TX to be synthesized to the voice synthesis server SSV in the step S1.

The HTTP server SH receives the request REQ and the transformation unit UTR transforms the text TX to be synthesized into a transformed text TXT in the step S2. This transformation consists in modifying the text to be synthesized as a function of characteristics of the text TX to be synthesized and/or characteristics of the synthesizer or synthesizers SY.

If the text TX to be synthesized is an e-mail, it comprises an e-mail that conforms to the RFC822 standard, i.e. the text TX to be synthesized specifies fields such as the sender, the receiver, the subject and the body. The transformation unit UTR then extracts these different fields in order to eliminate the names of the fields explicitly designated in the text TX to be synthesized and reformulates all of the fields into a transformed text TXT that is coherent for voice presentation of the e-mail. Appendix 2 gives one example of this transformation of an e-mail type text TX to be synthesized.

If the text TX to be synthesized is an SMS short message, it is often written using abbreviations, like a telegram. The transformation unit UTR corrects the text TX to be synthesized in order to recompose the text TX to be synthesized into a corrected text TXT including terms in the language of the text to be synthesized known to the synthesizer SY of the synthesis server SSV. Appendix 3 gives an example of the transformation of a short message (SMS) text TX to be synthesized.

Another example of a type of text to be synthesized is a mailing address, for example “13 av. Champs Elysées”. This is transformed by the transformation unit UTR into “thirteen avenue Champs Elysées”.

In a variant, the text TX to be synthesized is either presented directly in an XML (extensible Markup Language) format document or transformed by the transformation unit UTR into an XML format document.

In another variant, the type of the text TX to be synthesized is not transmitted as a parameter but is instead determined automatically by the transformation unit UTR carrying out a textual analysis of the text TX to be synthesized.

In another variant, the transformation does not depend on characteristics of the text TX to be synthesized, but on characteristics of the synthesizer or synthesizers SY, such as SSML (Speech Synthesis Markup Language) flags added to the text TX to be synthesized with a view to preparing the text TX for a synthesizer SY that can interpret SSML.

In another variant, the transformation unit UTR transforms the text TX to be synthesized (or the associated file containing the text to be synthesized) as a function of the formatting file that is a parameter of the resource address. This file is generally an XSLT (extensible Stylesheet Language Transformations) file if the text TX to be synthesized is an XML document. If the text TX to be synthesized is not an XML document, but has an implicit tree structure, the formatting file is based on that structure.

For example, in the case of a “database entry” text TX to be synthesized in an XML document, the XSLT formatting file specifies elements of the XML format document to be synthesized, the order of those elements and parameters of the voice synthesizer that in particular define a particular voice synthesis voice.

In another example, the text TX to be synthesized is an e-mail. An e-mail does not conform to the XML format but has an implicit tree structure comprising a header composed of fields such as the receiver, the sender, the subject, the body. The body may be composed of a plurality of elements such as paragraphs, a signature, another e-mail, etc. The formatting file specifies at the transformation level (for example in a manner specific to the type concerned) the order and/or the presence of the fields and/or the elements, as well as adding time delays and/or sound elements.

The text TX to be synthesized may be subjected to a plurality of transformations.

In the step S3, the language determination module MDL of the voice synthesis server SSV determines the language of the transformed text TXT to be synthesized in order for the translator TR, in the step S4, to translate the text TXT into a to-be-synthesized transformed text translated in the language that is a parameter of the resource address included in the service file FS.

Alternatively, the text TX or TXT to be synthesized, where applicable after it is transformed in the unit UTR, is again translated into a predetermined unique language if the language of the text TXT to be synthesized is different from the unique language. In this latter variant, it is not necessary to transmit the translation language as a parameter.

In another variant, the text TXT to be synthesized is not translated.

After the translation step S4, in the step S5 the voice synthesis server SSV selects the synthesizer SY most appropriate for voice synthesis of the text TX, TXT to be synthesized in order for the predetermined characteristics of the selected synthesizer SY to correspond to the characteristics of the text to be synthesized. These characteristics may be lumped with certain parameters in the service file FS, such as the translation language, or determined by analyzing the text TX, TXT to be synthesized, for example the number of characters, the context, etc.

In a variant, the synthesizers SY are distributed between the voice synthesis servers SSV1 to SSV3 represented in FIG. 1 and connected via the packet network RP. The location address of the voice synthesis server SSV1 to SSV3 that includes the most appropriate synthesizer SY is a characteristic of the synthesizer SY.

In a variant, the transformed text TXT to be synthesized is composed of terms in more than one language. The language determination module MDL recognizes the languages in the text TX, TXT to be synthesized and segments the latter into respective consecutive segments progressively as a function of the languages that have been recognized. The voice synthesis server SSV selects for each segment one of a plurality of synthesizers SY in the voice synthesis server SSV or distributed between the voice synthesis servers SSV1 to SSV3, as a function of the language of the segment, in order for the segment to be synthesized in the language of the segment.

The text TX to be synthesized or the transformed text TXT to be synthesized is transmitted to the selected synthesizer SY in order for the text TX, TXT to be synthesized, whether it has been translated or not, to be synthesized as a synthesized text TXS in the step S6.

In the step S7, the audio processing unit UTA processes the synthesized text TXS as a conventional sound file in order to modify the format of the sound file according to the format specified in the corresponding parameter in the service file FS, such as “MP3”, “WMA” or “WAV”, for example. In a variant, the format is not specified as a parameter of the resource address in the service file FS and the audio processing unit UTA always modifies the sound file associated with the synthesized text TXS according to a unique format.

In the step S8, the HTTP server SH transmits the voice server SVI the synthesized text TXS in the audio response REPA to the request REQ. The VXML interpreter IVX therefore has access to the sound file associated with the voice synthesis of the text TXT to be synthesized.

In a variant, the characteristics of the text TX, TXT to be synthesized, such as the type or the audio format, do not constitute additional parameters of the address but are determined automatically by the voice synthesis server SSV analyzing the text to be synthesized.

In another variant, certain parameters, such as the type or the audio format, are stored in a database of the voice synthesis server SSV in corresponding relationship to a client identifier and in this case the only parameter transmitted in the resource address is the client identifier, from which the parameters previously stored can be deduced.

In another variant the management server SGS and the synthesis server SSV are implemented in a unique server.

### Appendix 1

Syntax of the VXML command

<form>

<block>
<prompt>

<audio
src=“http://@IP_TTS/webCVOX.cgi?text=
‘Hello Word’&
type=‘e-mail’&
ltraduc=‘English’&
format=‘ ’”>
</audio>

</prompt>
</block>

</form>

### Appendix 2

### Transformation of an e-mail Text to be Synthesized

Source Text to be Synthesized:
From: “Dupont Henri” <henri_dupont@wanadoo.fr>
To: paul_lanou@wanadoo.fr
Subject: holiday
Date: Wed, 7 Jan. 2004 17:07:15+0100
MIME-Version: 1.0
Content-Type: multipart/alternative
X-Priority: 3
Content: Hi Paul, I hope you are well. I am writing about our planned winter holiday in February . . . .

Transformed Text:
You received an e-mail from Henri Dupont on 7 Jan. 2004 at 17:07.
The subject of this e-mail is “holiday”.
Here is the content of the e-mail: “Hi Paul, I hope you are well. I am writing about our planned winter holiday in February . . . ”

### Appendix 3

### Transformation of a Short Message Text to be Synthesized

Source Text TX to be Synthesized:
1) Ive bought sme cofy
2) sry bout dis arvo
3) film lol
4) Y? avent U cllD
5) hi Julien dis S Elodie I got my mob dis arvo Iz goin awy 2moz
6) w@ cnI do 4u 2 4give me
7) sry but I cnot cum dis evng HAGN :) fran
8) I cnot cll U, we'll do w@ we Z: 3h20 pm undR r trE n D prk! QSL or rng 1s f ur OK X lee.

Corresponding Transformed Text TXT:
1) I have bought some coffee
2) sorry about this afternoon
3) film very funny
4) why haven't you called
5) hi Julien this is Elodie I got my mobile this afternoon I am going away tomorrow
6) what can I do for you to forgive me
7) sorry but I cannot come this evening have a good night <audio src=“audio/up.wav”/>francs In this short message the “smiley” “:)” is replaced by the sound of laughter.
8) I cannot call you, we will do what we said: 15h20 under our tree in the park! reply or ring once if you're OK kiss lee.

1. A voice synthesis system for interactive voice services comprising an interactive voice server connected to a packet network dispensing a voice service to a user terminal by executing a service file associated with said voice service, and a voice synthesis server connected to the packet network and including voice synthesis means,
said interactive voice server comprising means for transmitting a request containing a text to be synthesized during the execution of said service file, said service file including an address designating a resource in said voice synthesis server and a command responsive to an audio format for commanding transmitting of said request to said voice synthesis server, and
said voice synthesis server comprising means for transforming said text to be synthesized into a transformed text as a function of a formatting file that is a parameter of the resource address in order for said voice synthesis means to synthesize said transformed text into a synthesized text, and means for transmitting an audio response including said synthesized text to said interactive voice server.

2. A system according to the claim 1, wherein said text to be synthesized is located by another resource address that is a parameter of said resource address.

3. A system according to claim 1, wherein the transforming means transforms said text to be synthesized as a function of characteristics of said text to be synthesized before said voice synthesis means synthesizes said text to be synthesized.

4. A system according to claim 3, wherein said characteristics of said text to be synthesized are a type, a format and a language of said text to be synthesized.

5. A system according to claim 4, wherein said type of said text to be synthesized may indicates one of an electronic mail, a short message and a multimedia message.

6. A system according to claim 1, wherein said transforming means transforms said text to be synthesized as a function of characteristics of said voice synthesis means before the voice synthesis means synthesizes said text to be synthesized.

7. A system according to claim 1, wherein said voice synthesis server comprises means for determining the language of said text to be synthesized and means for translating said text to be synthesized into a translated text in a translation language different from said language of said text to be synthesized that has been determined, said voice synthesis means synthesizing said translated text into a synthesized text in said translation language.

8. A system according to claim 1, comprising plural voice synthesis means in order for said voice synthesizer server to select one of said plural voice synthesis means to synthesize said text to be synthesized as a function of characteristics of said text to be synthesized.

9. A system according to claim 1, comprising a plural voice synthesis means, and wherein said voice synthesis server comprises means for segmenting said text to be synthesized into respective consecutive segments progressively as a function of recognized languages and selects one of said plural voice synthesis means for each segment as a function of the language of said segment in order for said segment to be synthesized in the language of said segment.

10. A system according to claim 8, wherein said plural voice synthesis means are divided between voice synthesis servers connected via said packet network.

11. A voice synthesis method for interactive voice services comprising execution of a service file in an interactive voice server connected to a packet network in order to dispense to a user terminal a voice service associated with said service file, said method comprising the following steps:
transmitting a request containing a text to be synthesized to a voice synthesis server connected to said packet network during the execution of said service file, said service file including an address designating a resource in said voice synthesis server and a command responsive to an audio format to command transmitting of said request,
transforming said text to be synthesized into a transformed text as a function of a formatting file that is a parameter of the resource address in order for voice synthesis means in said voice synthesis server to synthesize said transformed text into a synthesized text, and
transmitting an audio response including said synthesized text to the interactive voice server.

12. A method according to claim 11, wherein said transformation of said text to be synthesized into said transformed text is effected as a function of characteristics of said text to be synthesized before said voice synthesis server synthesizes said text to be synthesized.

13. A method according to claim 11, wherein said transformation of said text to be synthesized into said transformed text is effected as a function of characteristics of said voice synthesis means before said voice synthesis server synthesizes said text to be synthesized.

14. A method according to claim 12, wherein said transformation of said text to be synthesized into said transformed text is effected as a function of characteristics of said voice synthesis means before said synthesis server synthesizes said text to be synthesized.

15. A voice synthesis server for interactive voice services connected via a packet network to an interactive voice server dispensing a voice service to a user terminal by executing a service file associated with said voice service,
said voice synthesis server including:
voice synthesis means,
means for transforming a text to be synthesized, transmitted by said interactive voice server during execution of said service file in a request, said service file containing an address designating a resource in said voice synthesis server and a command responsive to an audio format for commanding transmitting of the request, into a transformed text as a function of a formatting file that is a parameter of the address of the resource in order for said voice synthesis means to synthesize said transformed text into a synthesized text, and
means for transmitting an audio response including said synthesized text to said interactive voice server.
